(19) United States
(12) Patent Application Publication
(10) Pub. No.: US 2020/0130995 A1
(43) Pub. Date: Apr. 30, 2020

(54) SYSTEM AND METHOD FOR AUTOMATICALLY PROVIDING ELEVATOR SERVICE IN A BUILDING TO A PASSENGER UPON THE PASSENGER LEAVING A ROOM IN THE BUILDING

(71) Applicant: OTIS ELEVATOR COMPANY, FARMINGTON, CT (US)

(72) Inventors: Naveen Atla, Puppalaguda (IN); Chennareddy Gogireddy, Hyderabad (IN)

(21) Appl. No.: 16/661,395

(22) Filed: Oct. 23, 2019

(30) Foreign Application Priority Data
Oct. 26, 2018 (IN) 201811040366

(51) Int. Cl. B66B 1/46; B66B 1/28; B66B 1/24; B66B 1/34

(52) U.S. Cl. CPC B66B 1/468; B66B 1/28; B66B 2201/101; B66B 1/3461; B66B 2201/4638; B66B 1/2408

(57) ABSTRACT

Disclosed is an elevator system including: a system controller that communicates with a first device and responsively controls an elevator car for transporting a passenger, the system controller is configured to render a plurality of determinations for transporting the passenger, including: a first determination that the first device is transmitting first data that is indicative of the passenger seeking elevator service, a second determination to assign the elevator car to provide elevator service to the passenger, and the system controller is configured to transmit a first instruction to the elevator car to effect the second determination.

### BACKGROUND

The embodiments herein relate to an elevator system and more specifically to a system and method for automatically providing elevator service in a building to a passenger upon the passenger leaving a room in the building.

Hotel rooms may be equipped with key card locks which are integrated with lock management systems (LMS). A door lock state may be continuously monitored by the LMS. If a guest intends on leaving their room he/she may have to lock the room door by removing a key card from a key card holder inside the room. Then he/she may have to walk to an elevator lobby and call the elevator a by manually actuating a button on a control counsel and wait for the elevator to arrive.

### SUMMARY

Disclosed is an elevator system comprising: a system controller that communicates with a first device and responsively controls an elevator car for transporting a passenger, the system controller is configured to render a plurality of determinations for transporting the passenger, including: a first determination that the first device is transmitting first data that is indicative of the passenger seeking elevator service, a second determination to assign the elevator car to provide elevator service to the passenger, and the system controller is configured to transmit a first instruction to the elevator car to effect the second determination.

In addition to one or more of the above disclosed features, or as an alternate, wherein the first data indicates that a door lock has been engaged by the passenger.

In addition to one or more of the above disclosed features, or as an alternate, wherein the first device receives a communication indicating that the power to one or more devices in a room is in an off state.

In addition to one or more of the above disclosed features, or as an alternate, the first data indicates that the first device is disposed on a first level, whereby the system controller determines the passenger requires elevator service at a first lobby.

In addition to one or more of the above disclosed features, or as an alternate, the first data provides a room identifier indicating that the one or more devices are located in a specific room.

In addition to one or more of the above disclosed features, or as an alternate, the first data is received from a card controller, and the card controller determines the power in the specific room is in the off state.

In addition to one or more of the above disclosed features, or as an alternate, the one or more devices includes an air conditioning system.

In addition to one or more of the above disclosed features, or as an alternate, the system controller renders the second determination, if the elevator car is at a second lobby, and the first instructions include the elevator car traveling to the first lobby and idling at the first lobby until engaged by the passenger.

In addition to one or more of the above disclosed features, or as an alternate, the communication is received by the system controller over a wireless network.

In addition to one or more of the above disclosed features, or as an alternate, the wireless network a personal area network (PAN).

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 illustrates features of a disclosed elevator system according to an embodiment; and

FIG. 3 illustrates a process executed by the disclosed elevator system according to an embodiment.

### DETAILED DESCRIPTION

A detailed description of one or more embodiments of the disclosed apparatus and method are presented herein by way of exemplification and not limitation with reference to the Figures.

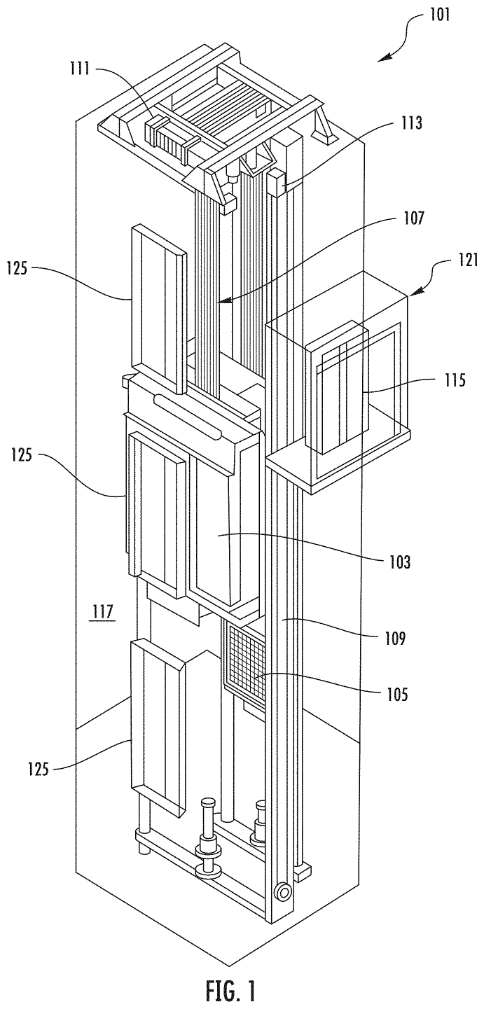

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator hoistway 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator hoistway 117, such as on a support or guide rail, and may be configured to provide position signals related to a position of the elevator car 103 within the elevator hoistway 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator hoistway 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator hoistway 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator hoistway 117.

Although shown and described with a roping system including tension member 107, elevator systems that employ other methods and mechanisms of moving an elevator car within an elevator hoistway may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

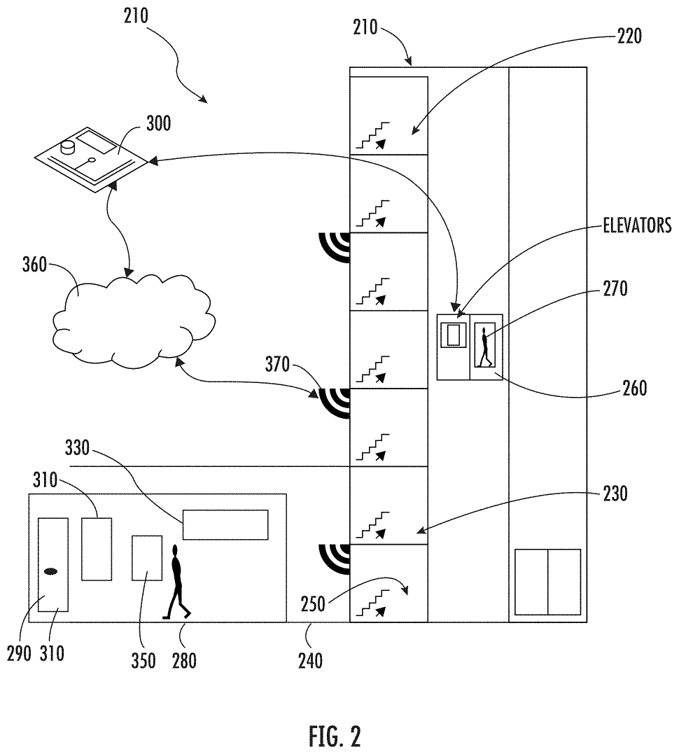

Turning to FIG. 2, disclosed is an elevator system 200 in a building 210 that includes a plurality of levels 220 and a respective plurality of lobbies 230. For example the first level 240 has a first lobby 250. The building 210 may include an elevator car 260 for transporting a passenger 270 between the plurality of lobbies 230. The first level 240 may be subdivided to include the first lobby 250 and a room 280.

The room 280 may fixedly include a first device 290 (e.g., a processor-based device or smart device) that is engageable by the passenger 270 when leaving the room 280. The system 200 may comprise a system controller 300 that communicates with the first device 290 and responsively controls the elevator car 260 to transport the passenger 270.

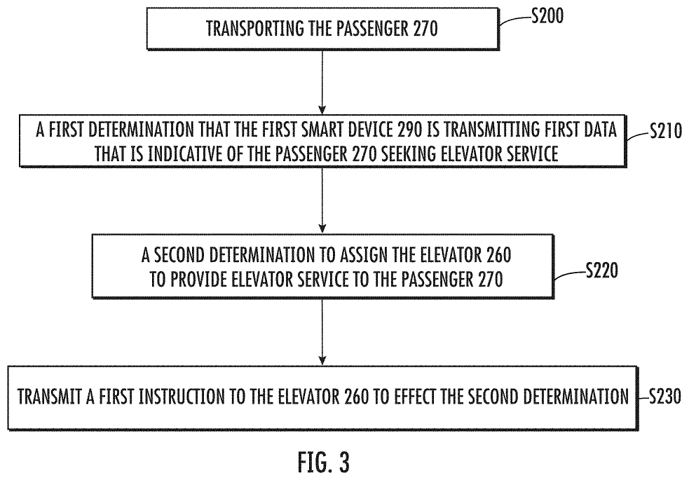

Turning to FIG. 3, the system controller 300 is configured to render a plurality of determinations when executing a process S200 for transporting the passenger 270. At step S210 the system controller 300 renders a first determination that the first device 290 is transmitting first data that is indicative of the passenger 270 seeking elevator service. At step S220 the system controller 300 makes a second determination to assign the elevator car 260 to provide elevator service to the passenger 270. At step S230 the system controller 300 is configured to transmit a first instruction to the elevator car 260 to effect the second determination.

According to an embodiment the room 280 has a door 310 that is an egress door and the first device 290 is a door lock. The first data may indicate that the door 310 has been engaged by the passenger 270. According to an embodiment the system includes a plurality of devices including the first device 290 and a second device 330 (e.g., a processor-based devices or smart devices). The second device 330 may be a first power controller for the room 280. According to an embodiment the first determination may include the system controller 300 communicating with the first power controller 330 to confirm that power to one or more utilities in the room 280 is in an off state.

According to an embodiment the first data may indicate that the first device 290 is disposed on the first level 240. From this the system controller 300 may determine the passenger 270 requires elevator service at the first lobby 250.

According to an embodiment the building 210 may comprise a distribution of plurality of the power controllers including the first power controller 330. The first data may provide a room identifier whereby the system controller 300 determines that the first power controller 330 controls power for the room 280.

According to an embodiment a third device 340 may be in the room 280. The third device 340 may be a card controller in operational communication with the first power controller 330. When the card controller 340 determines a card 350 is removed from the card controller 340, the first power controller 330 may set power to the one or more utilities in the room 280 to the off state. According to an embodiment the one or more utilities includes an air conditioning unit.

According to an embodiment when the system controller 300 renders the second determination, if the elevator car 260 is at the second lobby, the first instructions include the elevator car 260 traveling to the first lobby 250 and idling at the first lobby 250 until engages by the passenger.

According to an embodiment the plurality of devices communicate with the system controller 300 over a wireless network. The wireless network 360 may be a personal area network (PAN), for example, Bluetooth, accessible through one or more PAN beacons 370.

According to the above embodiments a system is disclosed which may continuously monitor door states available in a building/hotel from a controller which may be a lock management system (LMS). Whenever a door lock state is active/locked and the guest (passenger) is not in the room (which may be confirmed by checking a state of an air conditioner power supply inside the room), the system may obtain corresponding level information of the room from the LMS. The system may then instruct an elevator to provide service on the same level as the room so as to provide service to the passenger. For example a guest is allocated a room on a level in a hotel. Within the room, when the guest (passenger) removes the key card from the key card holder, the power supply controller turns power off in the room. When the door is locked as the person leaves the room, the system may read both the data from the lock management system and the energy management system to determine that guest (passenger) has left the room. Then the system may send an elevator to the level of the guest. Before the guest (passenger) arrives near the elevator, the assigned elevator may arrive to provide elevator service.

As used herein, “smart devices” may contain one or more processors capable of communication using with other such devices by applying wired and/or wireless telecommunication protocols. Non-limiting examples of a smart device include a mobile phone, personal data assistant (PDA), tablet, watch, wearable or other processor-based devices. Protocols applied by smart devices may include local area network (LAN) protocols and/or a private area network (PAN) protocols. LAN protocols may apply Wi-Fi technology, which is a technology based on the Section 802.11 standards from the Institute of Electrical and Electronics Engineers, or IEEE. PAN protocols include, for example, Bluetooth Low Energy (BTLE), which is a wireless technology standard designed and marketed by the Bluetooth Special Interest Group (SIG) for exchanging data over short distances using short-wavelength radio waves. PAN protocols may also include Zigbee, a technology based on Section 802.15.4 protocols from the Institute of Electrical and Electronics Engineers (IEEE). More specifically, Zigbee represents a suite of high-level communication protocols used to create personal area networks with small, low-power digital radios for low-power low-bandwidth needs, and is best suited for small scale projects using wireless connections. Wireless protocols may further include short range communication (SRC) protocols, which may be utilized with radio-frequency identification (RFID) technology. RFID may be used for communicating with an integrated chip (IC) on an RFID smartcard. Wireless protocols may further include long range, low powered wide area network (LoRa and LPWAN) protocols that enable low data rate communications to be made over long distances by sensors and actuators for machine-to-machine (M2M) and Internet of Things (IoT) applications.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An elevator system comprising:
a system controller that communicates with a first device and responsively controls an elevator car for transporting a passenger,
the system controller is configured to render a plurality of determinations for transporting the passenger, including:
a first determination that the first device is transmitting first data that is indicative of the passenger seeking elevator service,
a second determination to assign the elevator car to provide elevator service to the passenger, and
the system controller is configured to transmit a first instruction to the elevator car to effect the second determination.

2. The system of claim 1 wherein the first data indicates that a door lock has been engaged by the passenger.

3. The system of claim 2 wherein the first device receives a communication indicating that the power to one or more devices in a room is in an off state.

4. The system of claim 3 wherein the first data indicates that the first device is disposed on a first level, whereby the system controller determines the passenger requires elevator service at a first lobby.

5. The system of claim 4 wherein the first data provides a room identifier indicating that the one or more devices are located in a specific room.

6. The system of claim 5 wherein the first data is received from a card controller, and the card controller determines the power in the specific room is in the off state.

7. The system of claim 6 wherein the one or more devices includes an air conditioning system.

8. The system of claim 7 when the system controller renders the second determination, if the elevator car is at a second lobby, and the first instructions include the elevator car traveling to the first lobby and idling at the first lobby until engaged by the passenger.

9. The system of claim 3 wherein the communication is received by the system controller over a wireless network.

10. The system of claim 9 wherein the wireless network a personal area network (PAN).

11. A method comprising:
rendering, with a controller for an elevator system, a first determination that a first device is transmitting first data that is indicative of a passenger seeking elevator service,
rendering, with the controller, a second determination to assign an elevator car to provide elevator service to the passenger, and
transmitting, with the controller, a first instruction to the elevator car to effect the second determination.

12. The method of claim 11 wherein the first data indicates that a door lock has been engaged by the passenger.

13. The method of claim 12 wherein the first device receives a communication indicating that the power to one or more devices in a room is in an off state.

14. The method of claim 13 wherein the first data indicates that the first device is disposed on a first level, whereby the system controller determines the passenger requires elevator service at the first lobby.

15. The method of claim 14 wherein the first data provides a room identifier indicating that the one or more devices are located in a specific room.

16. The method of claim 15 wherein the first data is received from a card controller, and the card controller determines the power in the specific room is in the off state.

17. The method of claim 16 wherein the one or more devices includes an air conditioning system.

18. The method of claim 17 when the system controller renders the second determination, if the elevator car is at the second lobby, the first instructions include the elevator car traveling to the first lobby and idling at the first lobby until engages by the passenger.

19. The method of claim 18 wherein the plurality of devices communicate with the system controller over a wireless network.

20. The method of claim 19 wherein the wireless network a personal area network (PAN).
